(19) United States
(12) Patent Application Publication
(10) Pub. No.: US 2011/0313827 A1
(43) Pub. Date: Dec. 22, 2011

(54) APPLICATION USAGE REWARDS PLATFORM

(75) Inventors: Kenneth A. Lobb, Sammamish, WA (US); Shiraz J. Cupala, Seattle, WA (US); Todd Garnet Wagner, Seattle, WA (US); Henry Charles Sterchi, Redmond, WA (US)

(73) Assignee: MICROSOFT CORPORATION, Redmond, WA (US)

(21) Appl. No.: 12/821,089

(22) Filed: Jun. 22, 2010

(51) Int. Cl. G06Q 30/00; G06Q 10/00; G06Q 50/00

(52) U.S. Cl. 705/14.12; 705/14.14; 705/14.31; 705/14.33

(57) ABSTRACT

A system and method of providing incentives for users to use computer applications. Application use by a user is tracked and participation credits are provided to the user based on the tracked use. Credits can be provided based on time of use and/or application based incentives, such as achievements in a game. A limit may be placed on the amount of credits a user may have at any time, inducing the user to redeem the tokens. Credit redemption is provided by redemption system which rewards users with prizes directly or based on a random generation of prize rewards under the guise of game play based on chance.

### BACKGROUND

Consumer loyalty programs generally reward consumers who use a product or service with points which can be translated into discounts. These discounts can come in the form of free products or services related to those for which the points are acquired. Both the reward and the merchandise are generally related to currency. That is, points are rewarded based on dollars spent and the rewards generated are based on a monetary value. Airline mileage programs and credit card point programs are two examples of product loyalty programs. Mileage programs tie point acquisition to miles flown, which often correlates to money spent on the flight. Similarly, points in credit card programs are generally tied to dollars spent using the card.

There are generally no loyalty based programs for participating on on-line game play or computer application usage. Achievements are generally limited to in-game rewards, and can be rewarded with additional game play elements within the context of the game itself. Thus reward programs are generally tied to the particular game economy in which a reward was received, and loyalty programs do not currently apply to general applications.

### SUMMARY

Technology is presented to provide incentives for users to use computer applications. Use of an application by a user is tracked and incentive credits are provided to the user based on the use. Tokens can be provided based on time of use and/or application based incentives, such as achievements in a game or number of times an activity is performed. A limit may be placed on the amount of tokens a user may have at any time, inducing the user to redeem the tokens. Credit redemption is provided by redemption system which rewards users with prizes based on a fixed or random generation of prize rewards under the guise of game play based on chance or other premise.

In one embodiment, the technology is a computer implemented method to provide user incentives to application user. Use of one or more applications by a user is tracked and redemption tokens provided based on milestones in the use. Prize redemption scenarios are provided, with each scenario including a set of prizes suitable for use in one or more of the applications. Uses of reward redemption tokens are received and prizes issued randomly in response to the redemption of the tokens.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an isometric view of an exemplary gaming and media system.

FIG. 2 is an exemplary functional block diagram of components of the gaming and media system shown in FIG. 1.

FIG. 3 illustrates a block diagram of the components of a mobile device.

FIG. 4 is a block diagram of an exemplary processing device.

FIG. 5 is a block diagram representing a first system for implementing the present technology.

FIG. 6 is a flow chart illustrating a first method which may be performed by a user in accordance with the first embodiment of the technology illustrated in FIG. 5.

FIG. 7 is a flow chart illustrating a method performed by the redemption service in accordance with the first embodiment of the technology.

FIG. 8 is a block diagram illustrating a second system for implementing a second embodiment of the present technology.

FIG. 9 is a flow chart performed by a user in accordance with the second embodiment of the present technology.

FIG. 10 is a flow chart illustrating a process performed by a reward service in accordance with the second embodiment of the present technology.

FIG. 11 illustrates the data structure utilized for maintaining records in accordance with the second embodiment of the present technology.

FIG. 12 illustrates a method for calculating appropriate rewards and seating a redemption application.

FIG. 13 is an exemplary reward application interface provided by a gaming console.

FIG. 14 is an exemplary game which may be played for rewards in accordance with the present technology.

FIG. 15A is a user interface for selecting a reward set in accordance with the present technology.

FIG. 15B illustrates a skinned reward interface provided by a console.

FIGS. 16A and 16b illustrate an alternative a user interface for selecting a reward set in accordance with the present technology

FIG. 17A illustrates a game which may be performed on a mobile device in accordance with an alternative embodiment of the present technology.

FIG. 17B illustrates a redemption application which may be performed on a mobile device in accordance with the present technology.

FIG. 18 is a block diagram illustrating a third embodiment of a system for implementing a third embodiment of the present technology.

FIG. 19 illustrates a method performed by a user in accordance with the third embodiment of the present technology.

FIG. 20 illustrates a method performed by a redemption application in accordance with a third embodiment of the present technology.

### DETAILED DESCRIPTION

Technology is presented for rewarding participants for use of applications, such as games or productivity applications. The technology provides rewards which need not be tied to the economy of the application, allowing users to receive rewards or prizes relevant to and usable in other applications. The technology tracks a use of an application by a user and provides usage credits to the user based on the use. Credits can be provided based on time of use and/or application based incentives, such as achievements in a game. A limit may be placed on the amount of credits a user may have at any time, thereby encouraging the user to try to redeem the credits. Reward selection is provided in a set of rewards tailored to the user's level of achievement or use of a game or application. Users can redeem credits distributed in the form of tokens using an entertaining redemption system which rewards users with prizes based on a fixed or random generation of prize rewards under the guise of game play based on chance.

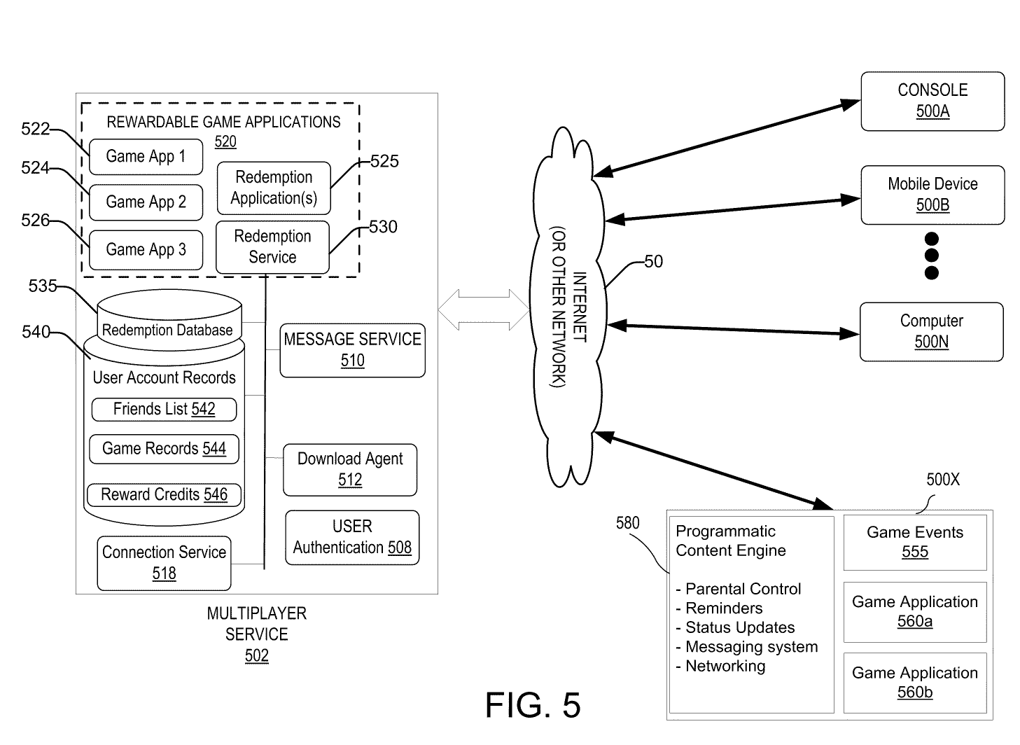

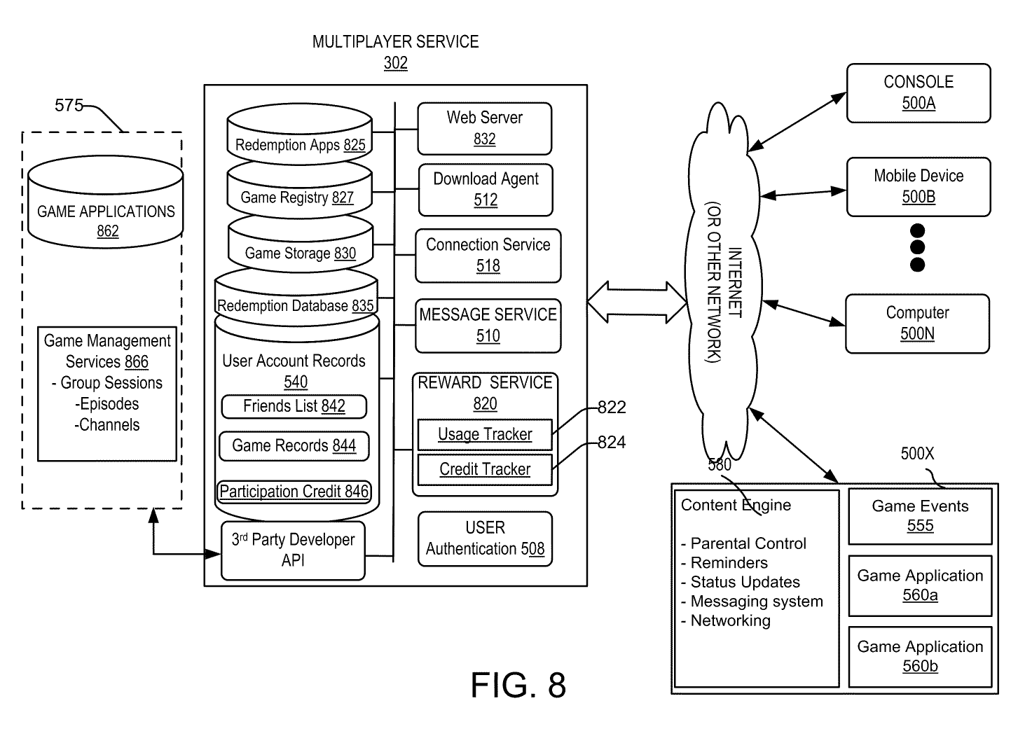

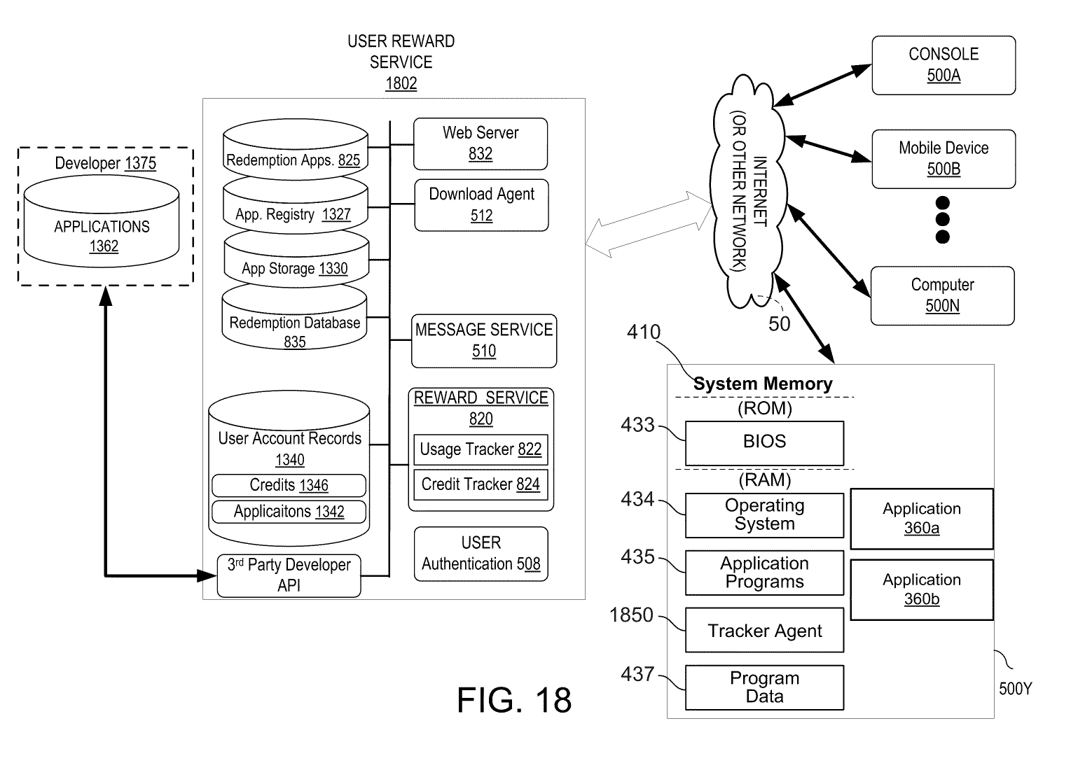

Multiple examples of the technology are provided. In one example, (FIGS. 18-20) the technology may be implemented to track usage of any type of application running on a processing device, and provide incentives based on the level of achievement use in one or more applications. In a second example (FIGS. 5-7), rewards are provided for use of a specific set of applications or games. In a third example, (FIGS. 8-12) a platform for implementing the reward system as a service is provided, allowing any game or application developer to provide applications and reward sets to be tracked by the platform.

In some examples, the technology is implemented in a multi-user gaming or application environment. In a game context, during the course of the game, a user progresses towards completing usage or “play” based milestones. A single milestone could have any number of benchmarks. For example, using a time based milestone, a user may hit the first benchmark or (rank 2) at 10 minutes played. A user could hit Rank 3 at 20 minutes played, and the like. Once a benchmark is hit, a redemption token is provided. The redemption token can take the form of a spin in a game of chance. Users constantly have something to strive for and look forward to just for playing a reward-based game.

Example milestones can include, but not be limited to: time played, used, or actions accomplished in a game; time using a productivity application or emails sent using an email program; cards dealt to player in a card game such as poker or blackjack; each card removed or properly placed in a solitaire game; attempted answers and/or correct answers in a trivia game, or photos captured of a given location.

Redemption applications can include spin or chance based games such as slot machines, dice, scratch off tickets or roulette. The redemption application is used to allow a user to attempt to earn rewards or prizes in any of their games or products. Reward scenarios are used to allow a user to choose a set of rewards for which they wish to play. For example, a user can choose to play for solitaire based prizes, and a redemption application can be skinned or branded to game to reflect the solitaire brand during those spins.

Since a reward token can be earned from product “A” but used to earn an award in product “B”, the technology is flexible to consumer needs and wants. Developers of productivity applications such as email programs which may be difficult to provide rewards for may participate in the system of the present technology. This encourages a feeling in users of an identifiable feature or brand that exist across various reward games and products. Reward scope and complexity can vary greatly based on needs. Some rewards can merely be a number or value. Other rewards can be digital products or consumer loyalty items such as pins, collectable badges, medals and the like.

In other examples, the technology is implemented as a platform based use tracking environment. In this context, as a user makes use of an application, use of the application is tracked and a user progresses towards completing usage based milestones. Participation credit for the application can be rewarded using a time based milestone. Once the user receives sufficient credits, the user may redeem the credits using the aforementioned game based redemption system or other redemption systems. Credit based rewards sets from which a user may retrieve rewards are based not on the amount of credit provided, but on the users' progress in the application or game.

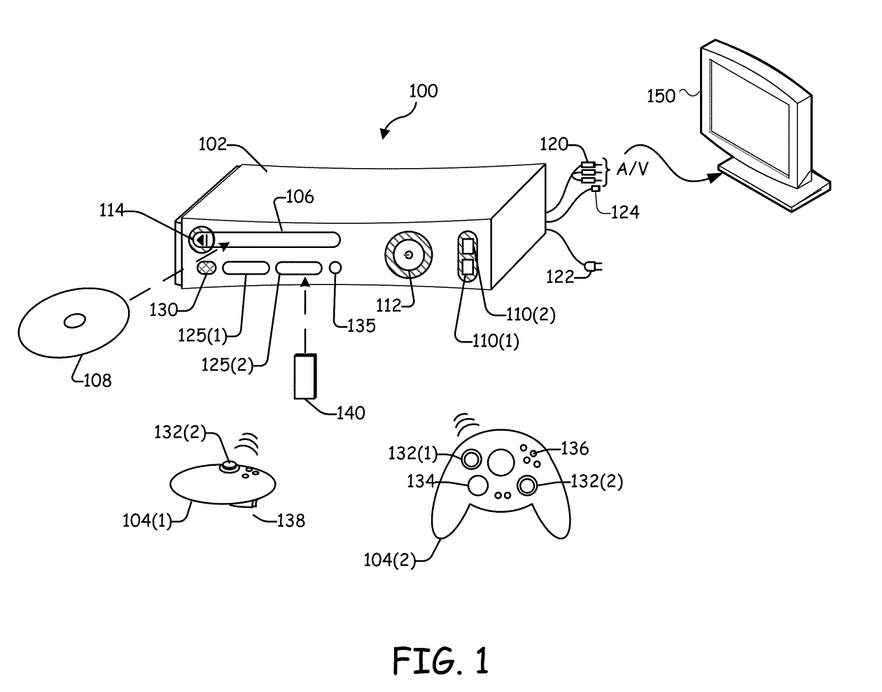

The technology may be used in any number of systems and operating environments. Various processing devices are illustrated in FIGS. 1-4.

FIG. 1 shows an exemplary gaming and media system 100. The following discussion of FIG. 1 is intended to provide a brief, general description of a suitable environment in which concepts presented herein may be implemented. As shown in FIG. 1, gaming and media system 100 includes a game and media console (hereinafter “console”) 102. In general, console 102 is one type of computing system, as will be further described below. Console 102 is configured to accommodate one or more wireless controllers, as represented by controllers 104(1) and 104(2). Console 102 is equipped with an internal hard disk drive (not shown) and a portable media drive 106 that support various forms of portable storage media, as represented by optical storage disc 108. Examples of suitable portable storage media include DVD, CD-ROM, game discs, and so forth. Console 102 also includes two memory unit card receptacles 125(1) and 125(2), for receiving removable flash-type memory units 140. A command button 135 on console 102 enables and disables wireless peripheral support.

As depicted in FIG. 1, console 102 also includes an optical port 130 for communicating wirelessly with one or more devices and two USB (Universal Serial Bus) ports 110(1) and 110(2) to support a wired connection for additional controllers, or other peripherals. In some implementations, the number and arrangement of additional ports may be modified. A power button 112 and an eject button 114 are also positioned on the front face of game console 102. Power button 112 is selected to apply power to the game console, and can also provide access to other features and controls, and eject button 114 alternately opens and closes the tray of a portable media drive 106 to enable insertion and extraction of a storage disc 108.

Console 102 connects to a television or other display (such as monitor 150) via A/V interfacing cables 120. In one implementation, console 102 is equipped with a dedicated A/V port (not shown) configured for content-secured digital communication using A/V cables 120 (e.g., A/V cables suitable for coupling to a High Definition Multimedia Interface “HDMI” port on a high definition monitor 150 or other display device). A power cable 122 provides power to the game console. Console 102 may be further configured with broadband capabilities, as represented by a cable or modem connector 124 to facilitate access to a network, such as the Internet. The broadband capabilities can also be provided wirelessly, through a broadband network such as a wireless fidelity (Wi-Fi) network.

Each controller 104 is coupled to console 102 via a wired or wireless interface. In the illustrated implementation, the controllers 104 are USB-compatible and are coupled to console 102 via a wireless or USB port 110. Console 102 may be equipped with any of a wide variety of user interaction mechanisms. In an example illustrated in FIG. 1, each controller 104 is equipped with two thumbsticks 132(1) and 132(2), a D-pad 134, buttons 136, and two triggers 138. These controllers are merely representative, and other known gaming controllers may be substituted for, or added to, those shown in FIG. 1.

In one implementation, a memory unit (MU) 140 may also be inserted into controller 104 to provide additional and portable storage. Portable MUs enable users to store game parameters for use when playing on other consoles. In this implementation, each controller is configured to accommodate two MUs 140, although more or less than two MUs may also be employed. In another embodiment, a Universal Serial Bus (USB) flash memory storage may also be inserted into controller 104 to provide additional and portable storage.

Gaming and media system 100 is generally configured for playing games stored on a memory medium, as well as for downloading and playing games, and reproducing pre-recorded music and videos, from both electronic and hard media sources. With the different storage offerings, titles can be played from the hard disk drive, from an optical disk media (e.g., 108), from an online source, or from MU 140.

During operation, console 102 is configured to receive input from controllers 104 and display information on display 150. For example, console 102 can display a user interface on display 150 to allow a user to perform the operations of the disclosed technology as discussed below.

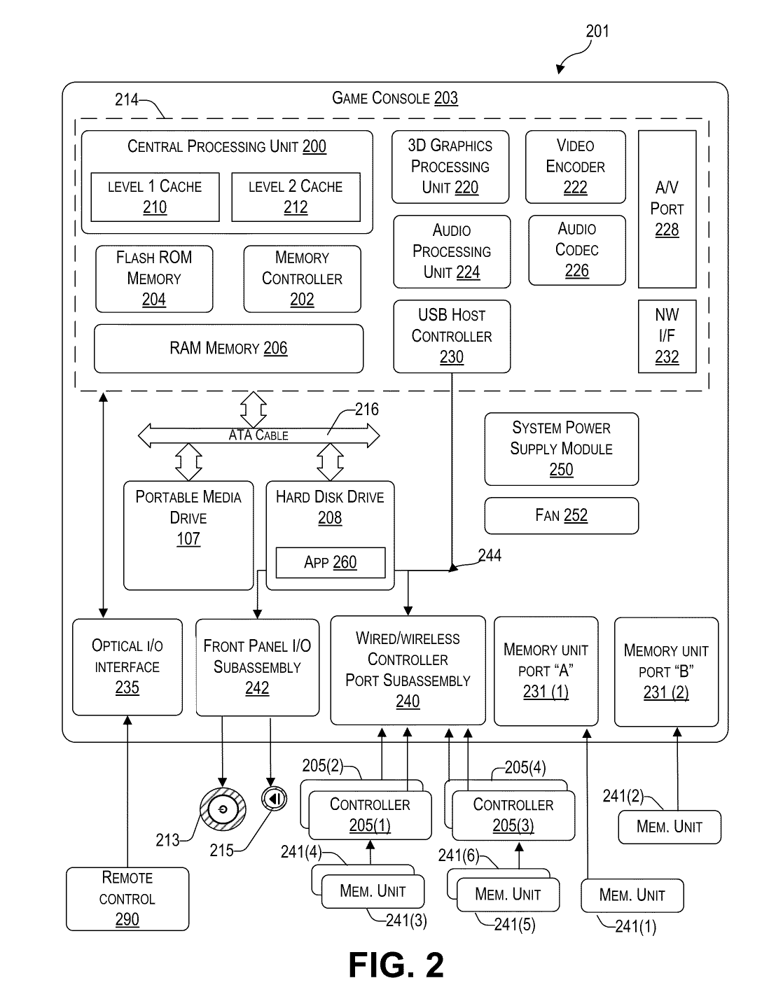

FIG. 2 is a functional block diagram of gaming and media system 201 and shows functional components of the gaming and media system 201 in more detail. Console 203 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 107. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 107 are shown connected to the memory controller 202 via the PCI bus and an AT Attachment (ATA) bus 216. However, in other implementations, dedicated data bus structures of different types can also be applied in the alternative.

A three-dimensional graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 2 shows module 214 including a USB host controller 230 and a network interface 232. USB host controller 230 is shown in communication with CPU 200 and memory controller 202 via a bus (e.g., PCI bus) and serves as host for peripheral controllers 205(1)-205(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 2, console 203 includes a controller support subassembly 240 for supporting four controllers 205(1)-205(4). The controller support subassembly 240 includes any hardware and software components needed to support wired and wireless operation with an external control device, such as for example, a media and game controller. A front panel I/O subassembly 242 supports the multiple functionalities of power button 213, the eject button 215, as well as any LEDs (light emitting diodes) or other indicators exposed on the outer surface of console 203. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 241(1) and 241(2) are illustrated as being connectable to MU ports “A” 231(1) and “B” 231(2) respectively. Additional MUs (e.g., MUs 241(3)-241(6)) are illustrated as being connectable to controllers 205(1) and 205(3), i.e., two MUs for each controller. Controllers 205(2) and 205(4) can also be configured to receive MUs (not shown). Each MU 241 offers additional storage on which games, game parameters, and other data may be stored. Additional memory devices, such as portable USB devices, can be used in place of the MUs. In some implementations, the other data can include any of a digital game component, an executable gaming application, an instruction set for expanding a gaming application, and a media file. When inserted into console 203 or a controller, MU 241 can be accessed by memory controller 202. A system power supply module 250 provides power to the components of gaming system 201. A fan 252 cools the circuitry within console 203.

An application 260 comprising machine instructions is stored on hard disk drive 208. When console 203 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 201 may be operated as a standalone system by simply connecting the system to monitor a television, a video projector, or other display device. In this standalone mode, gaming and media system 201 enables one or more players to play games, or enjoy digital media, e.g., by watching movies, or listening to music. However, with the integration of broadband connectivity made available through network interface 232, gaming and media system 201 may further be operated as a participant in a larger network gaming community, as discussed in connection with FIG. 8.

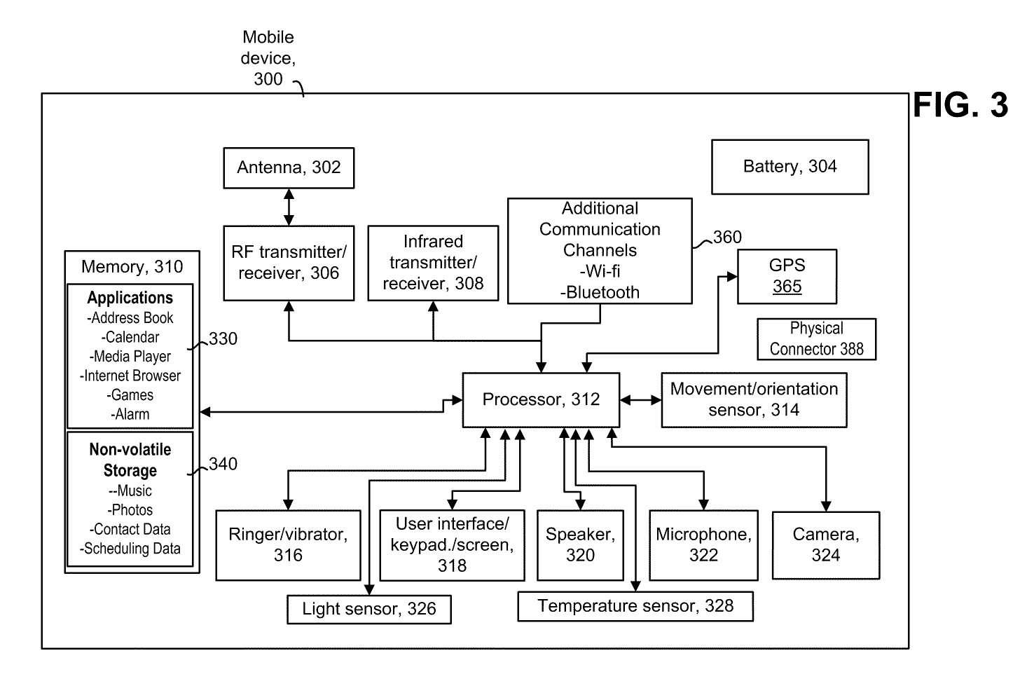

FIG. 3 depicts an example block diagram of a mobile device. Exemplary electronic circuitry of a typical m phone is depicted. The phone 300 includes one or more microprocessors 312, and memory 310 (e.g., non-volatile memory such as ROM and volatile memory such as RAM) which stores processor-readable code which is executed by one or more processors of the control processor 312 to implement the functionality described herein.

Mobile device 300 may include, for example, processors 312, memory 310 including applications and non-volatile storage. The processor 312 can implement communications, as well any number of applications, including the interaction applications discussed herein. Memory 310 can be any variety of memory storage media types, including non-volatile and volatile memory. A device operating system handles the different operations of the mobile device 300 and may contain user interfaces for operations, such as placing and receiving phone calls, text messaging, checking voicemail, and the like. The applications 330 can be any assortment of programs, such as a camera application for photos and/or videos, an address book, a calendar application, a media player, an internet browser, games, an alarm application, other third party applications, the interaction application discussed herein, and the like. The non-volatile storage component 340 in memory 310 contains data such as web caches, music, photos, contact data, scheduling data, and other files.

The processor 312 also communicates with RF transmit/receive circuitry 306 which in turn is coupled to an antenna 302, with an infrared transmitted/receiver 308, and with a movement/orientation sensor 314 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 312 further communicates with a ringer/vibrator 316, a user interface keypad/screen 318, a speaker 320, a microphone 322, a camera 324, a light sensor 326 and a temperature sensor 328.

The processor 312 controls transmission and reception of wireless signals. During a transmission mode, the processor 312 provides a voice signal from microphone 322, or other data signal, to the transmit/receive circuitry 306. The transmit/receive circuitry 306 transmits the signal to a remote station (e.g., a fixed station, operator, other cellular phones, etc.) for communication through the antenna 302. The ringer/vibrator 316 is used to signal an incoming call, text message, calendar reminder, alarm clock reminder, or other notification to the user. During a receiving mode, the transmit/receive circuitry 306 receives a voice or other data signal from a remote station through the antenna 302. A received voice signal is provided to the speaker 320 while other received data signals are also processed appropriately.

Additionally, a physical connector 388 can be used to connect the mobile device 100 to an external power source, such as an AC adapter or powered docking station. The physical connector 388 can also be used as a data connection to a computing device. The data connection allows for operations such as synchronizing mobile device data with the computing data on another device.

A global positioning service (GPS) receiver 365 utilizing satellite-based radio navigation to relay the position of the user applications enabled for such service.

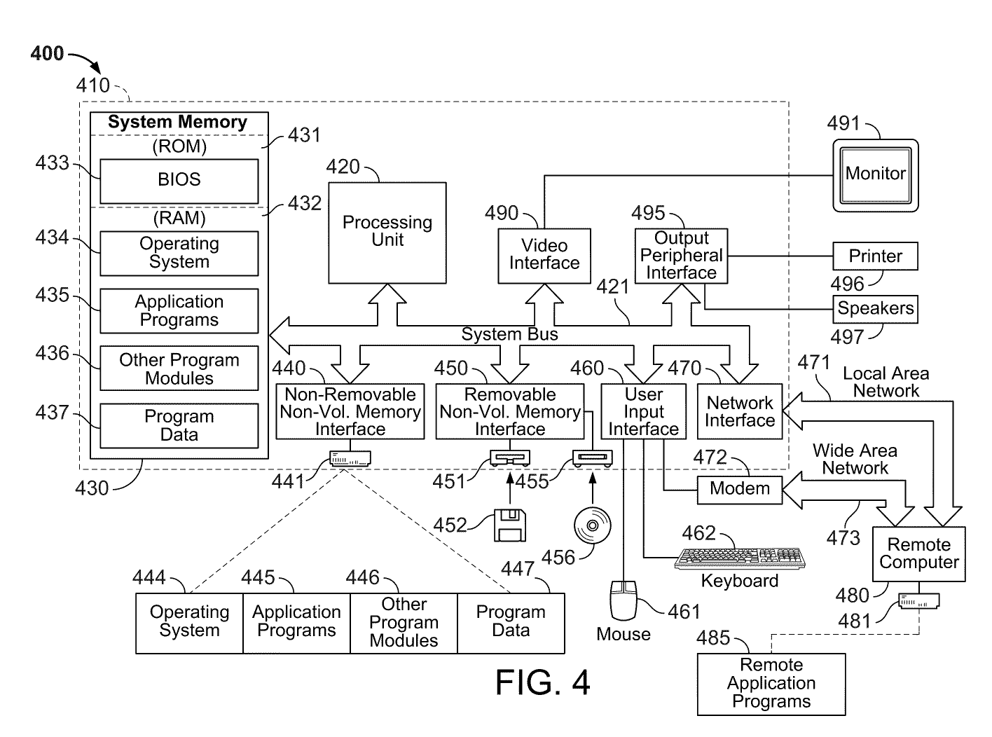

FIG. 4 illustrates an example of a suitable computing system environment 400 such as a personal computer. With reference to FIG. 4, an exemplary system for implementing the technology includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrates a hard disk drive 440 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through an non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 20 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through a output peripheral interface 490.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

FIGS. 5-7 illustrate one embodiment of the technology wherein an incentive system is provided. The system of FIG. 5-8 provides incentives for using a specific set of rewardable game application 520. Incentives are provided using one or more redemption applications 525 which themselves resemble games.

FIG. 5 is a block diagram illustrating a system which may be utilized in implementing the first embodiment of the present technology. FIG. 5 illustrates a multi-player gaming and reward service 502 which is coupled via a network 50 to one or more processing devices 500A, 500B, 500N, 500X. Network 50 may be a public network, a private network, or a combination of public and private networks such as the Internet. Each of the processing devices may comprise one or more of the processing devices illustrated in FIGS. 1 through 4 herein. These include a console 500A, a mobile device 500B, computer 500N, or a console 500X.

Console 500X illustrates functional components of applications and events which may be occurring on any one or more of the devices 500A, 500B, 500N, 500X. For example, a console 500X may include a number of game applications 560A, 560B which are executed by the processing device of the console 500X. One or more game events 555 may be generated by each of the game applications and stored on the console 500X. Events may be returned to the gaming service or transmitted to other users utilizing other devices 500A, 5008, 500N by a connection service 518 in the multi-player gaming service 502. Each device 500X may include a content engine which executes one or more functions to enable game play and/or application usage on the processing device 500X. The content engine can include, for example, parental controls, reminders, status updates, an internal messaging system, and networking capabilities to enable the devices to couple to the internet or other network 50.

Multi-player gaming service 502 includes a set 520 of game applications including game application 1, 522, game application 2, 524, and game application 3, 526. Each game application can be played by a user on one of the associated processing devices 500A, 500B, 500N, 500X for participation credits in the form of redemption tokens which may be used in redemption applications 525 to attempt to obtain prizes in a redemption service 520. Various methods of token or participation credit redemption may be utilized with the present technology. Reward or prize distribution to token holders upon an attempt to redeem the token is controlled by the redemption service 530. The rewards need not be linked to any of the particular games 522, 524, 526 played by the user to acquire the token, but can be provided for other games not played, or non-game related items. In the embodiment shown in FIG. 5, game applications 520, redemption applications 525 and redemption service provide rewards or prizes usable within one or more of the game applications with application 520. In alternative embodiments, prizes need not be so limited.

Gaming service 502 may further include a user authentication service 508, wherein each user of one or more of the processing devices 500A, 5008, 500N, 500X has associated therewith a unique user identifier, such as a gamer tag, which is used to uniquely identify the user within the multi-player gaming service 502. When a user seeks to play one of the game applications 522, 524, 526, or play game applications 560A, 560B with other users of other processing devices, connection by and/or between the users is controlled by first requiring each of the users to authenticate themselves to the multi-player gaming service 502 user authentication service 508. The connection service 518 allows different users on different processing devices to play game applications resident on those devices with other users, and maintains connections between the users. An exemplary connection service is Microsoft's Xbox LIVE® service provided by Microsoft Corporation, Redmond, Wash.

A multi-player gaming service 502 may further include a redemption database 535, and user account records 540. The redemption database 535 contains records of prizes which may be available through one or more of the redemption applications 525. User account records 540 may include items such as a friend's list, individual game records 544, and a record of the user's reward tokens received. In the embodiment illustrated in FIG. 5, reward game application 520 comprises a set of game applications and reward applications for which a user can play and receive rewards. In the embodiments illustrated with respect to FIGS. 8 through 19, below, any game application, or any other application used in a processing device, such as a productivity application, can be the subject of the reward redemption service and rewards retrieved and products provided by the redemption applications.

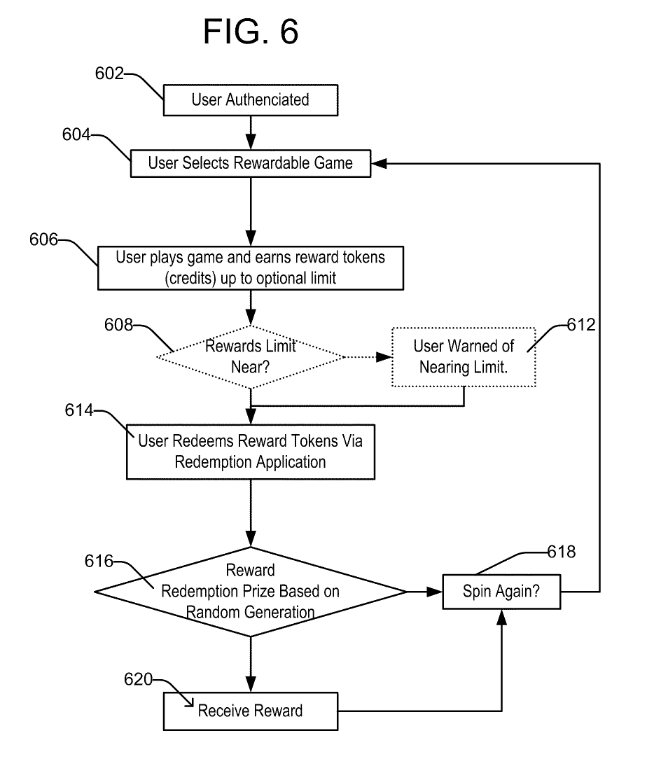

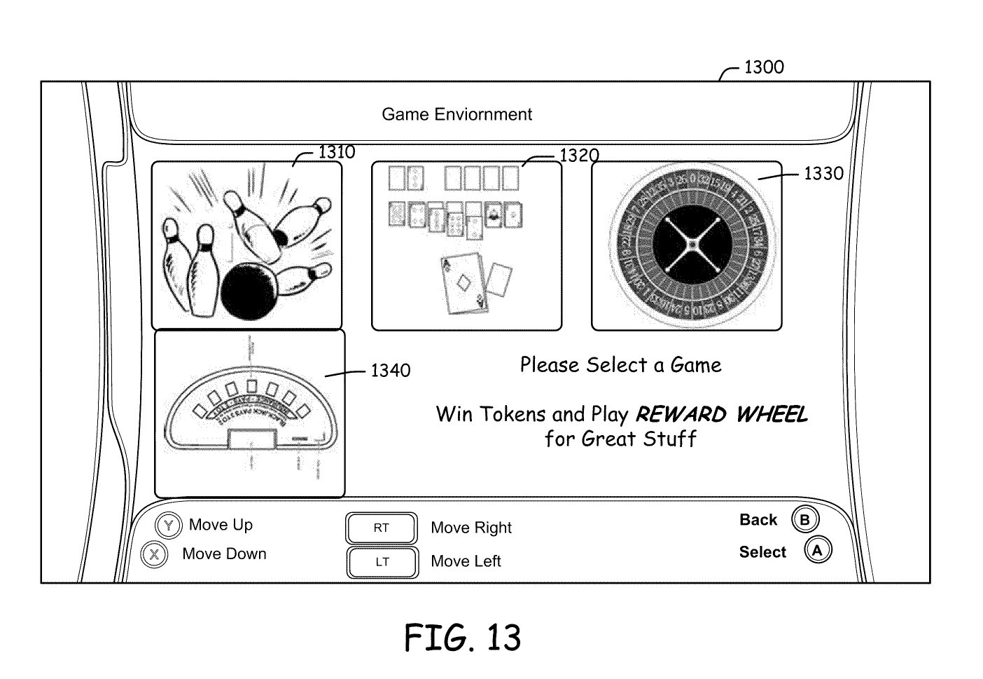

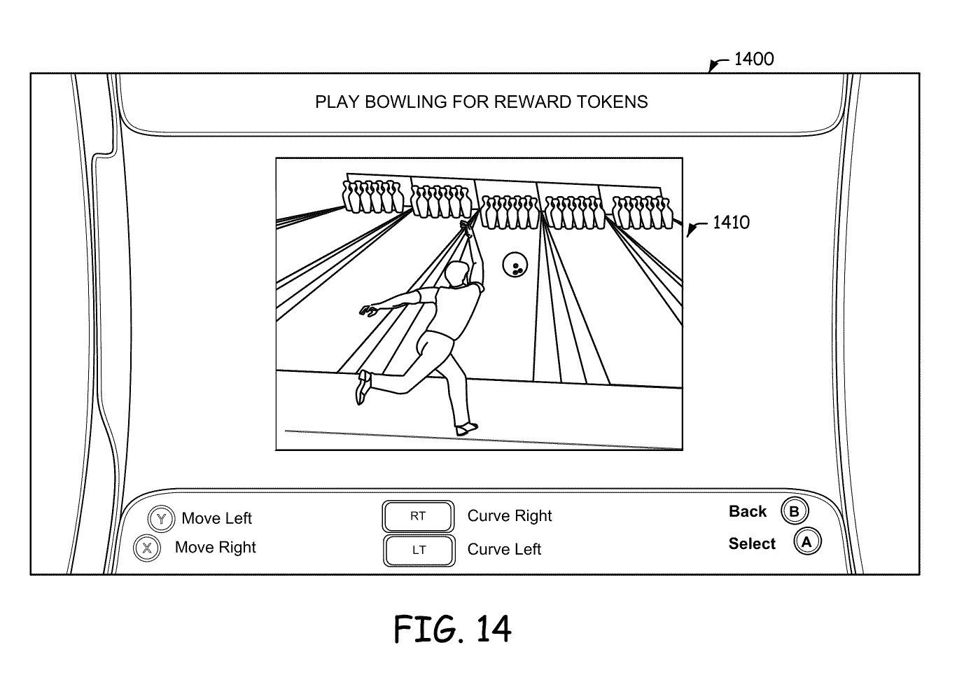

FIG. 6 illustrates a method performed by a user who seeks to participate in a multi-player gaming services with reward game applications 520. At 602, a user is authenticated by providing authentication credentials and an associated user identifier. At 604, the user selects to play a reward game from one of the available reward games such as games 522, 524, 526. An example of a user selection interface for reward games is illustrated in FIG. 13, below. As shown in FIG. 13, a user may have a selection of games provided on the user interface 1300, which include, for example, a bowling game 1310, a solitaire game, 1320, a roulette game 1330 and a poker game 1340. The games illustrated in FIG. 13 are merely exemplary and should not be construed as limiting the types of games which can be included in the reward game applications 520. An exemplary bowling game which may be played for redemption tokens is illustrated in FIG. 14.

Once the user selects a reward game at 604, the user may play the game at 608 and be rewarded for playing the game with reward tokens. When a user selects a reward game at 604, the user may be prompted to download the game to the user's processing device, or may play the game via a code which is run within a virtual machine, such as a web browser. At 606 a user plays the selected game and accumulates tokens up to an optional limit. If a participation credit is used, the limit is a limit on the amount of tokens a user may posses at any given point in time. Once the user redeems tokens, he may acquire as many as he redeems, so long as the limit is not exceeded. The token limit is designed to encourage the user to return to a redemption application 525 in order to redeem the redemption tokens and participate in the redemption applications. In systems where no upper limit of redemption tokens are used, users may be unwilling to use the redemption tokens. The limit provided on the redemption tokens provides users with an incentive to use the redemption tokens in reward game applications. At 608 when the user is nearing a rewards limit, the user may be provided with a warning at 612 that the user is nearing a limit, as a further incentive to encourage the user to participate in a redemption application. It should be understood that steps 608 and 612 are optional if a limit is used and are not used if no limit is in use.

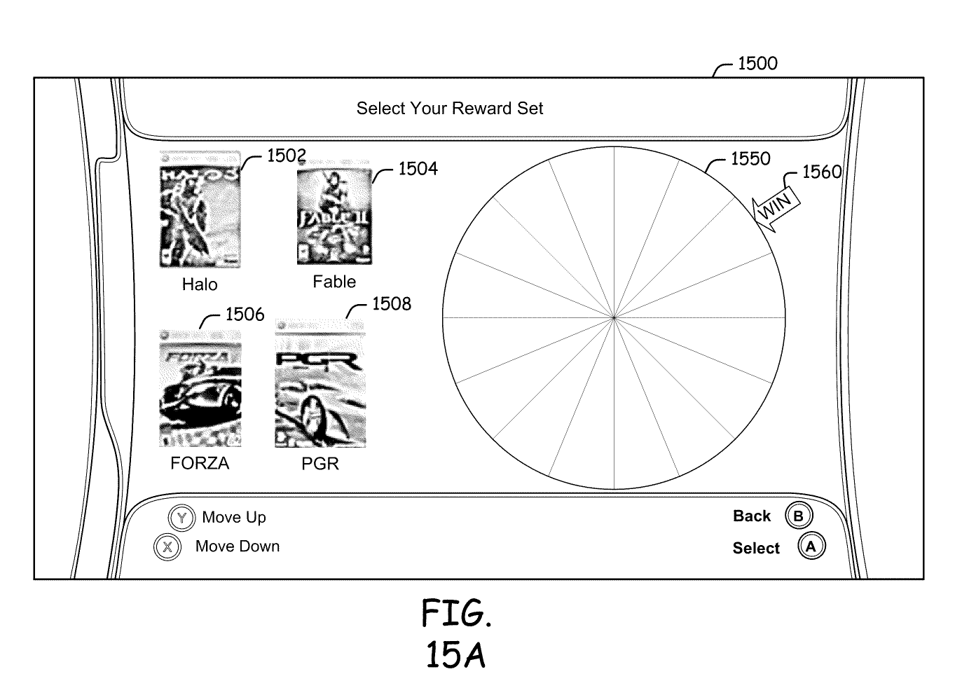

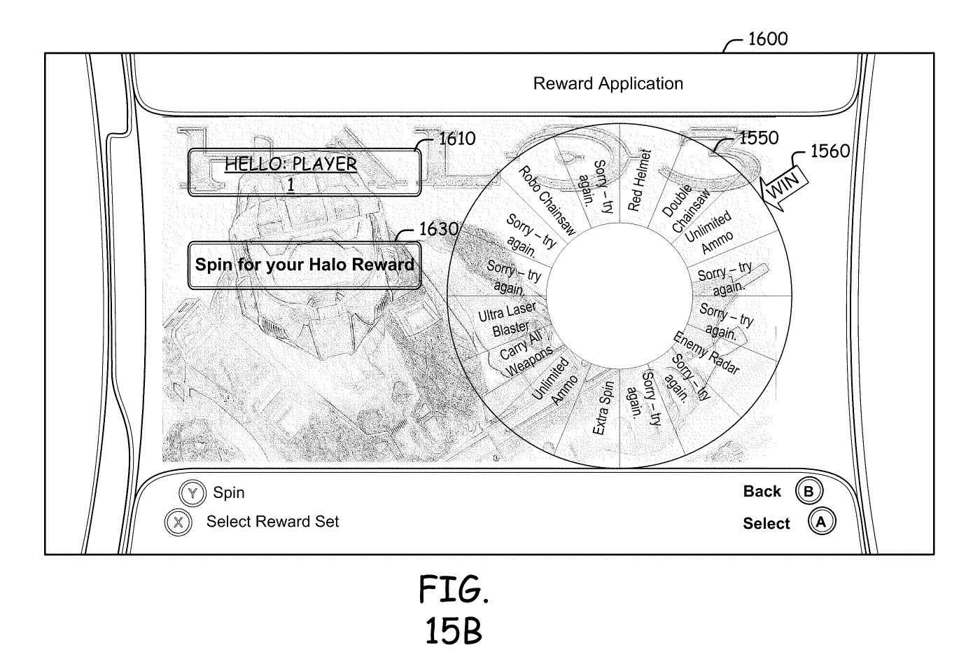

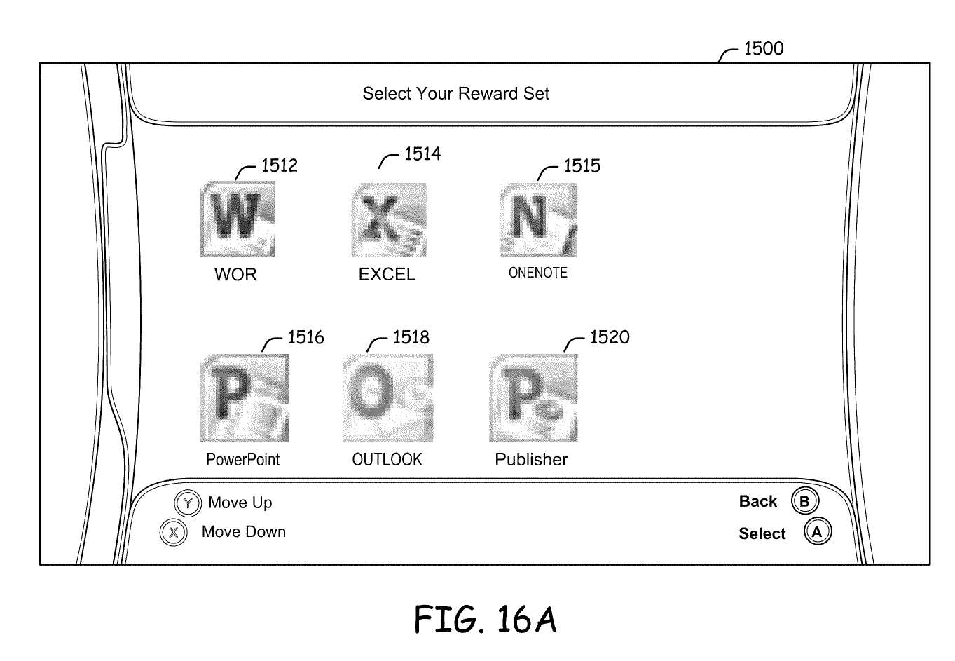

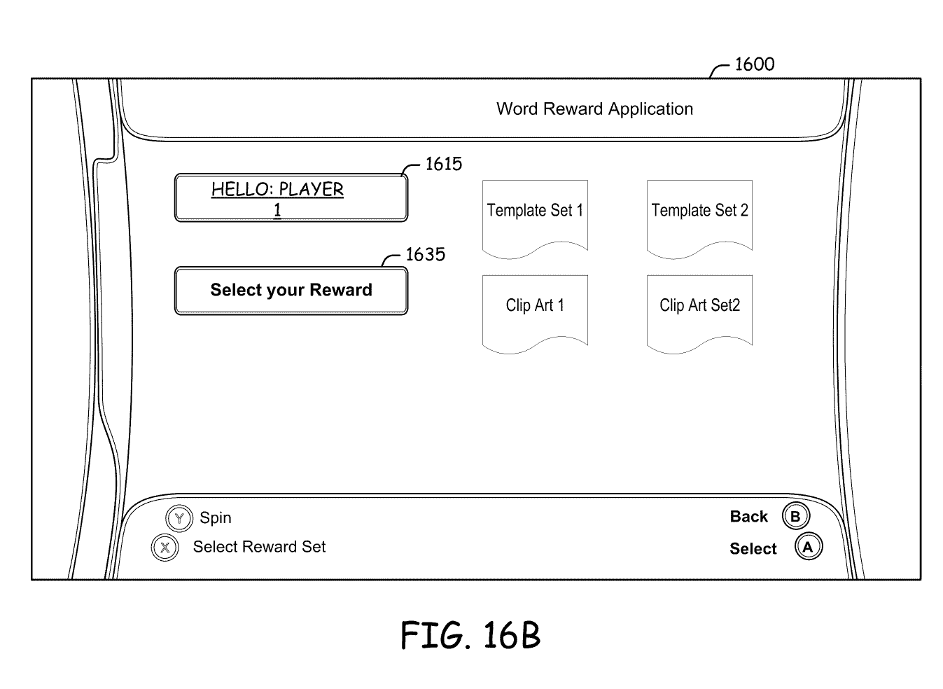

At 614, the user will select to participate in a redemption application. An exemplary redemption application utilizes random number generator in conjunction with a gaming motif to reward users with prizes for participating in the redemption application. One example of a redemption application is illustrated below in FIG. 15 and FIG. 16. In this example, described more fully below, the redemption application is a roulette wheel, and the motif is the game of roulette, where the user spins the roulette wheel in order to take a chance at receiving a prize from the redemption application.

At 616, a reward redemption prized may or may not be awarded to the user. In one embodiment, a random number generator is utilized to reward the user with a redemption prize based on a match between a value assigned to the user upon redemption of the redemption token and a value generated by the random number generation. If the user “wins,” a reward will be received at 620. The reward received at 620 will, in one embodiment, comprise digital content which is delivered to the user electronically via the network, or stored in association with the user's account record, for use in applications or games provided by the multiplayer gaming service 502. For example, the user may be rewarded for playing solitaire with one or more additional decks of cards, opportunities for larger prizes, opportunities to play with different game room environments, or other custom content provided by the multi-player gaming service. If the user does not win a prize at 616, the user may be prompted to play again at 618. Even if the user is awarded a prize at 616, the user may play as many times as the user has tokens to redeem.

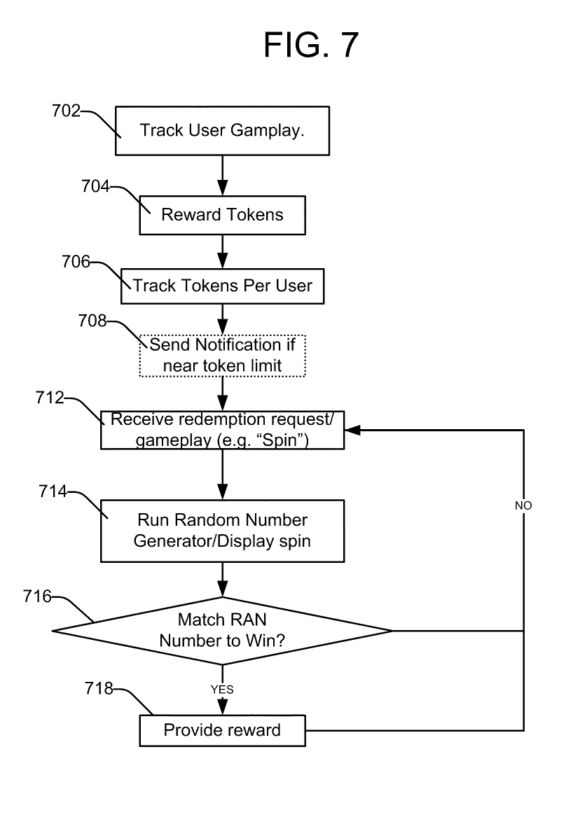

The redemption service 530 may perform a method such as that illustrated in FIG. 7. At 702, the redemption service tracks user game play and rewards tokens based on the game play up to a limit at 704. In one embodiment, the rewarding of tokens is based on the amount of time a user spends participating in one or more of the game applications 522, 524, 526. The time-based metric is independent of achievements a user makes within the particular games. The time based metric, in conjunction with the chance based rewards, provides all users, regardless of skill, with an opportunity to receive rewards for participating in a game. In an alternative embodiment, reward tokens may additionally be provided based on incentives for game play within the game itself. For example, achievements within the game can be utilized to supplement a revision of reward tokens at 704. At 706, the number of tokens per user is tracked. This may be performed by storing the number of award tokens to a data record 546 associated with a particular user account record 540. The user may be warned at 708 if the user is nearing a limit on the amount of tokens the user may have at any time. Step 708 is optional. Again, this limit incentivizes the user to participate in a redemption application to try and redeem the rewards for content. At 712, the redemption service will receive a request for participation in a particular redemption application 525. The system will receive a request to redeem a token through user or “play” of a redemption application at 714. At 716, a redemption based award will be awarded at 716 based on a random number generation matched to a winning number, presented in conjunction with the game motif selected by the user. If a reward is provided, digital content will be transmitted to the user at 718. If not, the user may be prompted to “play again” and return to step 712.

FIGS. 8-12 illustrate a second embodiment a system for implementing the present technology. The system illustrated in FIG. 8 provides a platform which allows third party developers 575 to provide gaming or other applications into a system which can provide usage tracking and reward sets. Illustrated therein is a multiplayer service 802 wherein any processor executed application may be utilized in conjunction with a reward service 820. Gaming applications may include any application provided by the multi-player gaming service administrator or third party developers. In FIG. 8, elements having the same reference numbers as those in FIG. 5 illustrate like components.

Multiplayer service 802 includes a reward service 820 having a usage tracker 822 and a participation credit tracker 824. Multiplayer service 802 includes one or more redemption applications 825, a game registry 827, a game storage 830, a redemption database 835, and user account records 840. User account records 840 may include the user's friend list 842, individual game records and achievements 844, and a record of the user's participation credit received 846. Multiplayer service 802 also includes a third party application programming interface 850 which allows third party application developers 575 to provide their own game applications 862 in conjunction with the multiplayer service 802. In one embodiment, game applications are stored in game storage 830 and may be provided to the consoles 500A, 500B, 500N, 500X utilizing a download agent 512. This allows game applications to be stored and run on the individual processing devices, or game applications may be provided through a web server 832. Various components of the applications may be run on the multi-player gaming service and/or the consoles or processing devices. Game registry 827 allows third party gaming developers 575 having gaming applications 862 to register the applications with the multi-player gaming service 802. In alternative embodiments, multi-player games are administered and provided directly by third party developers 575, but utilize services of the multi-player gaming service 802, such as the download agent and connection service, to allow users having access to consoles to connect to each other. Third party developers 575 may provide one or more game applications 862 and game management services at 866. Game management services 866 can provide updates on user sessions, including where game play lobbies and rooms of users gather for multi-player game connections, various episodes, and games including episodic content, various gaming channels, (rooms for basic, intermediate, and advanced players, and the like.

In the embodiment shown in FIG. 8, any application, whether provided by the multi-player gaming service 802, or third party developer 375, can be utilized in conjunction with the reward service 820. Third party applications register with the game registry 827 and may, or may not, be provided in game storage 830 for delivery by the download agent 512. In accordance with the embodiment of FIG. 8, when a user participates in a game application 560a which is registered with the game registry 827, the reward service will track usage of the game, and/or achievements in the game and reward participation credit using the credit tracker 824. Participation may be in the form of redemption tokens for chance-based redemption applications or other credit currency, such as redeemable points, for other types of redemption applications. When a user achieves enough redemption credit, the user can participate in a redemption application 825 in order to retrieve a reward or incentive “prize” which may or may not be associated with the game or application the user is participating in. Prizes can be awarded for different games, including any game provided by the third party developer 575 or the multi-player gaming service 802. Digital content prizes can also be provided for any of a number of different products or services by any application provided by the gaming service provider or by the third party developer 375.

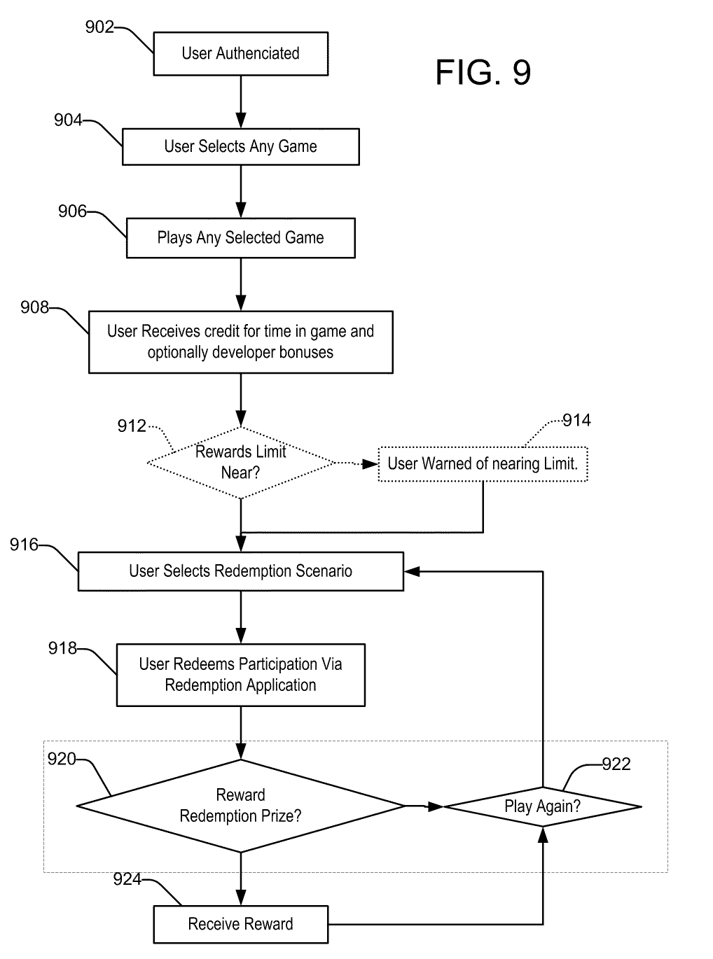

FIG. 9 illustrates a process performed by a user on a processing device (e.g. 500A, 500B, 500N, 500X) in accordance with the embodiment shown in FIG. 8. At 902, the user will authenticate using the user's credentials and select a game for play or application for use at 904. A user will use the application at 908 and will receive reward participation credits based on time and/or participation based incentives. It should be recognized that time in multiple games can be accumulated towards credits by the user. In one embodiment, credit is granted up to a limit. Optionally, as the user reaches a pre-defined limit of reward tokens at 912, the user will be warned of nearing the limit at 914.

At 916, the user will select one or more redemption scenarios. A redemption scenario includes a set of prizes and/or game redemption application artwork which will be provided to a redemption application. The redemption scenario allows the user to select reward sets of rewards which may be received on use or playing of a redemption application or when redeeming participation credits.

At 918, the user will select to redeem participation credit in for one or more prize sets in a redemption scenario. In one embodiment, the may include a user selecting a redemption scenario and exchanging credit for a prize at a fixed exchange rate or a tiered exchange rate. In a fixed or leveled system, one may choose from amongst rewards that match the user's experience or achievement level in the application. For example, if a user participates in the user of a photo editing application, the user may be presented with a reward such as a printing coupon for editing a certin number of pictures, and a discount coupon for a retail outlet (or software upgrade to a more advanced version of the software) when the user edits a higher of pictures. In this embodiment, steps 920 and 922 would not be performed, and the user would receive their prize at 924.

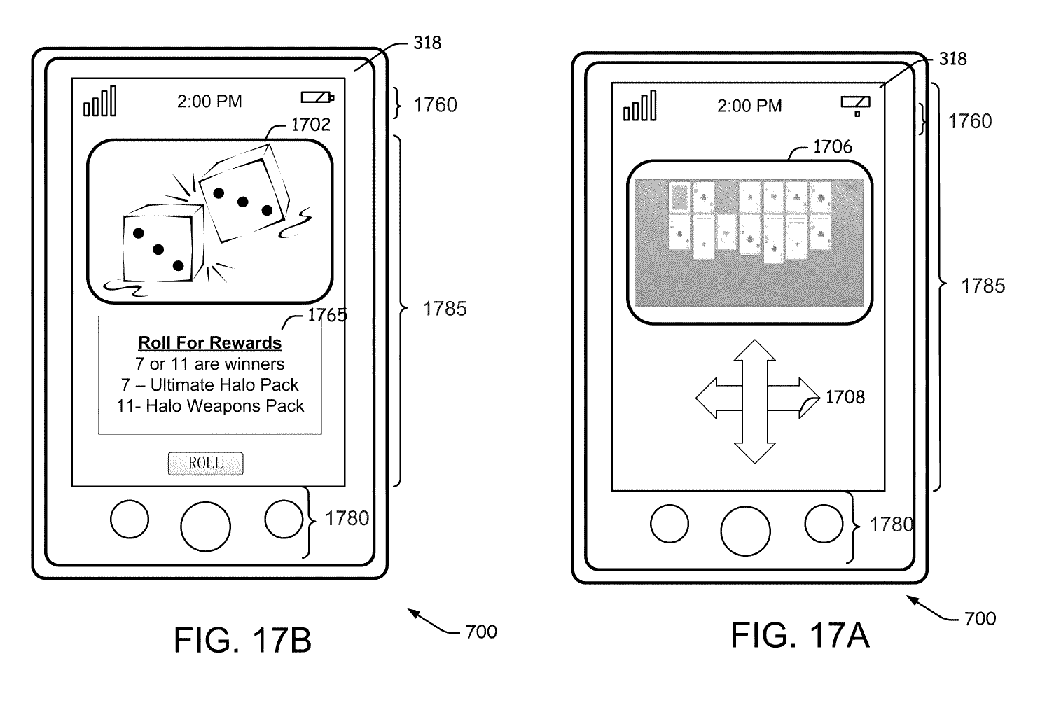

In an alternative embodiment, a user can redeem or “play” a redemption token via a redemption reward application. At 920, a redemption prize will be awarded or not rewarded based on a random number generation. When a user selects to redeem a redemption token, a random number may be assigned and when the user plays a redemption application, such as spinning a wheel in FIG. 16 rolling the dice in FIG. 17B, the If a user receives a prize at 924, digital content may be delivered to the user. If not, the user may be prompted to play again at 922.

At step 904 and 910 above, the user may select use of an application, which may comprise playing a game. One example of playing a game using the multiplayer service is Halo 3®. Halo 3® is a role playing game involving combat situations and challenges utilizing a variety of weapons. A user will receive redemption tokens for time spent in playing Halo and, optionally, awards achieved in playing the Halo game. When a user selects one or more redemption scenarios at 916, the user may select to play for rewards not based in the Halo game, but based in other reward or prize scenarios.

FIGS. 15A and 15B illustrate a redemption application user interface provided by a gaming console and the concept of reward scenarios. As illustrated in FIG. 15, a user interface 1500 will provide the user with an exemplary gaming application, in this case a roulette wheel or spinner 1550, with a win selector 1560, and a selection interface comprising one or more games 1502, 1504, 1506, 1508. A user who has played a application game different than Halo 3, (such as Fable) in step 908 above may, for example, select a Halo prize scenario 1502 from the user interface 1500. When selecting the Halo user interface, a skinned interface 1600 illustrated in FIG. 16 will be provided. The skinned interface can include a background image and prizes on spinner 1650 which are populated by digital items or “prizes” which a user might wish to use in a new game of Halo. The prizes provided on spinner 1650 are specific to the Halo reward scenario. Reward scenarios may be provided for any number of different games or applications, or may be provided from particular content providers, or third party developers. For example, a third party developer may decide to provide a reward scenario for all the products in its catalog, or specific products within the catalog, and products other than games.

When a user selects to redeem a redemption token by, for example, a spin of the wheel for one of the rewards, rewards received at 924 will be those specific to those included in the reward set. The grant of a reward or prize is based on the random number generation overlaid by game play in spinning the wheel to seek mating of elements on the spin wheel to a selector 1560.

FIGS. 16A and 16B illustrate a redemption application provided by a gaming console where a direct redemption system. In FIG. 16A, a user is selected with groups of reward sets with rewards suitable for use in Microsoft WORD 1512, Excel 1514, OneNote 1515, PowerPoint 1516, Outlook 1518 and Publisher 1520. Note that the reward sets are not linked to the application for which the reward was earned. Upon selection of reward set 1502, FIG. 16b illustrates the user may be presented with a group of prizes which the user receives upon selection. The prizes may vary. In FIG. 16B template and clip art sets are shown. For advanced or greater use based prizes, reward such as additional or advanced applications or upgrades may be provided.

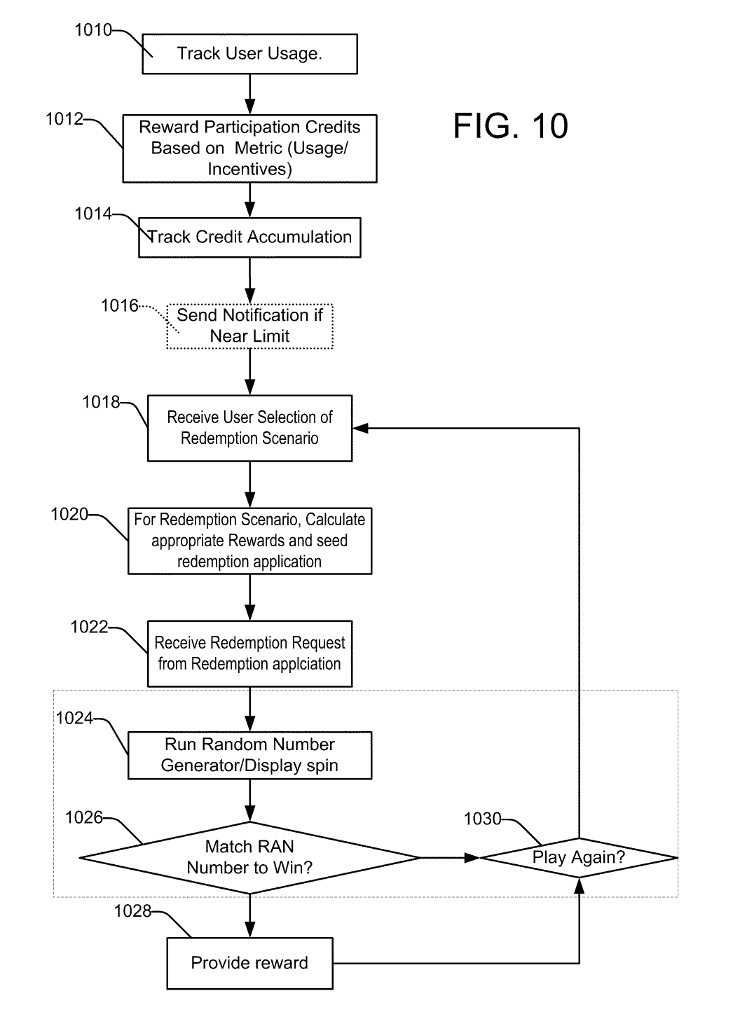

Returning to FIG. 10, a process is illustrated which is performed by redemption service 820. At 1010, the redemption service tracks usage of the application. Participation credits are awarded based on usage at 1012. In the embodiment of FIG. 10, credits are awarded based on time of use and/or in-application incentives based rewards within the game. Rewards are provided up to a limit at any time at 1012. Credit accumulation is tracked at 1014. Again, it should be recognized that multiple applications may be used for credit. If the user reaches the predefined limit at 1016, a warning may be issued. Step 1016 is optional. At 1018, the redemption service will receive a selection of one or more redemption scenarios, and at 1020, for each redemption scenario, the system will calculate appropriate rewards and see the redemption application as illustrated in 1016.

Step 1020 is useful where different games provide different levels of achievement within the game. For example, a user playing the game Fable may seek a Fable reward set. A useful Fable reward set for a user at level one in Fable would contain different elements than a user at higher levels. Awarding a set of rewards for users at a higher level would unfavorably benefit the lower level user. As such, at step 1020, the redemption service calculates the relative value of prizes in the redemption scenario to the user based on the user's level and the selection of the redemption scenario. The process can be applied to user of applications such as productivity and multimedia application base on use or expertise in the application as well. This process is illustrated with respect to a game below with respect to FIG. 12. At 1022, the service will receive a redemption request to use a participation credit. If the application is a random chance application, at 1024, the application will reward a redemption prize based on the random generation as displayed in a redemption application, as discussed above. Prizes will be rewarded at 1026 based on a random number match to a selected number for the redemption request. If a match is received, a prize will be rewarded at 1028. If not, the user will be prompted to play again at 1030 based on the outcome of the prize redemption scenario at 1026. If the redemption is a direct redemption of credit for a prize, steps 1024, 1026 and 1030 may be skipped.

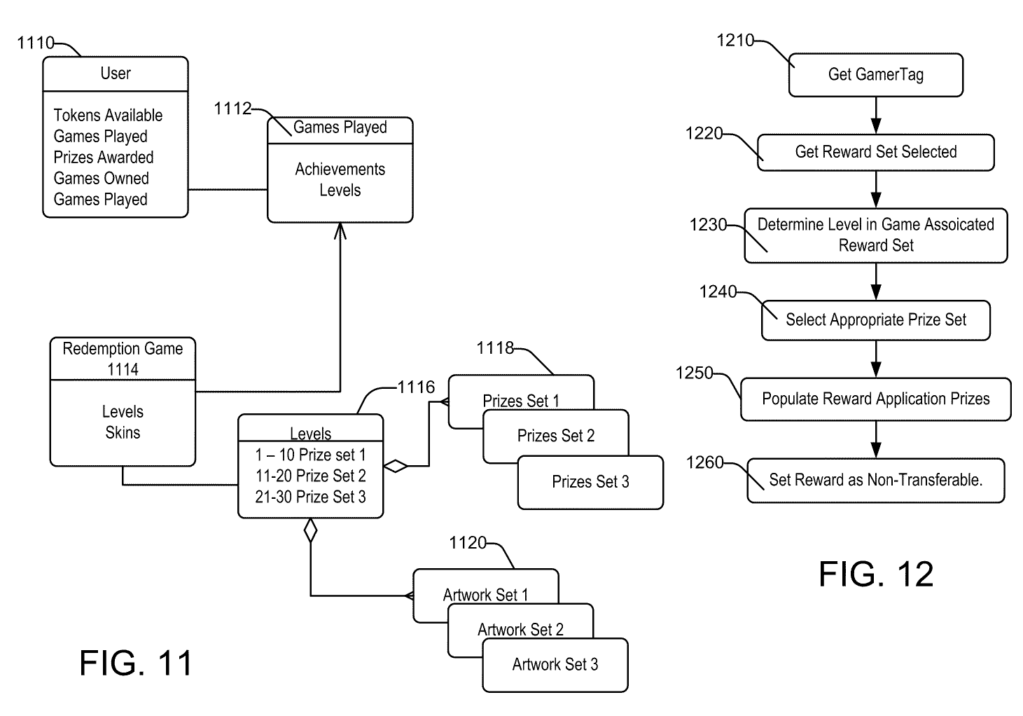

FIG. 11 illustrates an exemplary data structure utilized by the system illustrated in FIG. 8. FIG. 11 illustrates a game application tracking example using a redemption application played by a user with redemption tokens. Similar techniques may be utilized with respect to selecting a game set for other types of applications User records will contain, for each user at 1110, a record of the tokens available, the redemption applications previously played, the prizes awarded from the redemption applications, the games the user owns, and the games the user has played. For each of the games that a user has played at 1122, a record of the user's achievements and the user's level in the game is maintained. Each redemption game will have a record 1114 indicating what levels 1116 a user may have achieved and an association to one or more prize sets 1118 and associated art work 1120 for each level of prizes available to a prize set 1116. Prize sets and associate artwork can be considered a prize scenario. Each redemption application can access records of prize sets available for each level 1116 and associated artwork at 1120. Each game 1114 will have associated therewith a number of levels and skins available to it to apply to the user interface as illustrated in FIGS. 15 and 16.

FIG. 12 illustrates a method for performing step 1020 to calculate appropriate rewards and prize scenarios available to a redemption application for a game application. Similar techniques may be utilized with respect to selecting a game set for other types of applications. At 1210, the gamer tag for each user will be retrieved. The gamer tag is a unique identifier for a user and may associate the user with a user record, such as user record 1110. At step 1220, the user's selected reward set will be retrieved. At 1230, the user's level in a game will be determined and an appropriate reward set selected. The user's level in a game can be determined by reference to the games played record 1112 and the prize sets available for each level determined by reference of the redemption game to a levels record 1116. An appropriate prize set is selected at 1240. It should be understood that multiple prize sets may be available for each of the various levels or groups of levels defined in 1116. At 1250, the reward application prizes will be populated in the particular game motif utilized by the redemption system.

Optionally, at 1260, the reward may be set as nontransferable. In certain cases, it may be desirable to allow a user to transfer rewards to other users. For example, a reward game application may, for example, comprise the game solitaire. Some users may only wish to play solitaire and my not wish to play other games, but may achieve rewards based on the play of solitaire within the multi-player service. Another user having a relationship with the first user may play a number of different games. In this scenario, the first user playing solitaire may choose to spend their reward tokens on redemption sets which would provide prizes for the second user's multiplicity of games. In this case, once the solitaire playing user receives a reward, he may decide to transfer the reward to other users. Certain cases exist wherein the user should not be allowed to transfer rewards generated in this matter. This includes scenarios where a first user is a high level player in a particular game such as Fable, while the user to which the item might be transferred as a low level user. This would allow high-level users to provide disproportionate advantages to lower level users within the same game. Hence, items provided based on user level may be marked as nontransferable in this scenario.

FIG. 13 illustrates a user interface tree provided by a game console to allow users to select a rewardable game application such as applications 522, 524, 526, or any one of a number of applications provided by the multi-player gaming service. When a user selects, for example, the bowling game 1310, the user will be provided with a bowling game interface such as that illustrated in Figure 1400. Window 1410 is a bowling game wherein many of a various number of user controls, described above can be utilized to allow a user 1415 to bowl in a virtual environment 1410 illustrated in Figure 1410.

FIGS. 17A and 17B illustrate an alternative user interface and an alternative redemption application. FIG. 17A illustrates an alternative application which may accumulate redemption tokens or participation credit for a user. The application is provided on a mobile device 1700 having a status area 1760 and a display area 1785. An interface for a rewardable game playable on a mobile device 1700 includes a display screen 318 having a game window 1706 and a touch screen control 1708 allowing a user to play, for example, solitaire in the interface provided on phone 1700. The user can utilize the phone based application to generate participation based rewards in accordance with the methods described above. FIG. 17B illustrates a redemption application interface wherein a dice rolling application 1702 provides rewards based on a roll the dice at 1704. In this case, a user can select to roll the dice by using the touch interface 1765 which rolls the dice and, based on a random number generator, will display a 7 or 11 if the generator decides to reward a prize based on the random number output. As illustrated in FIGS. 16 and 17, any of a number of different game motifs may be utilized to provide a gaming incentive to users and conceal the use of the random number generator to generate prizes.

Use of the random number generator allows the system administrator to limit the amount of prizes which may be available to be rewarded through the system. In addition, the random number generator provides an element of chance in a separate redemption activity to users which is limited in time. The redemption application can be utilized in scenarios where the user does not have time to play a complete game, but has time to participate in the limited games of chance which can be implemented using the random number generator.

FIGS. 18-20 illustrate yet another embodiment of the technology wherein the system tracks usage of any type of application which may be used by a user. Elements in the figures having the same number as those illustrated in FIGS. 5 and 8 illustrate like elements to those discussed with respect to FIGS. 5 and 8.

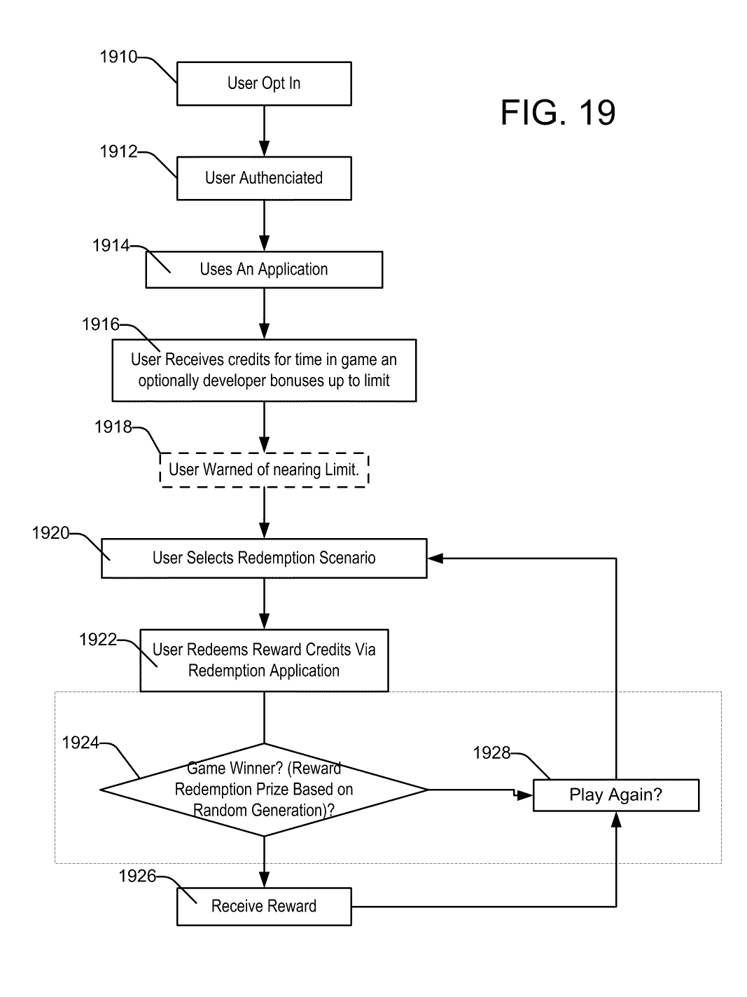

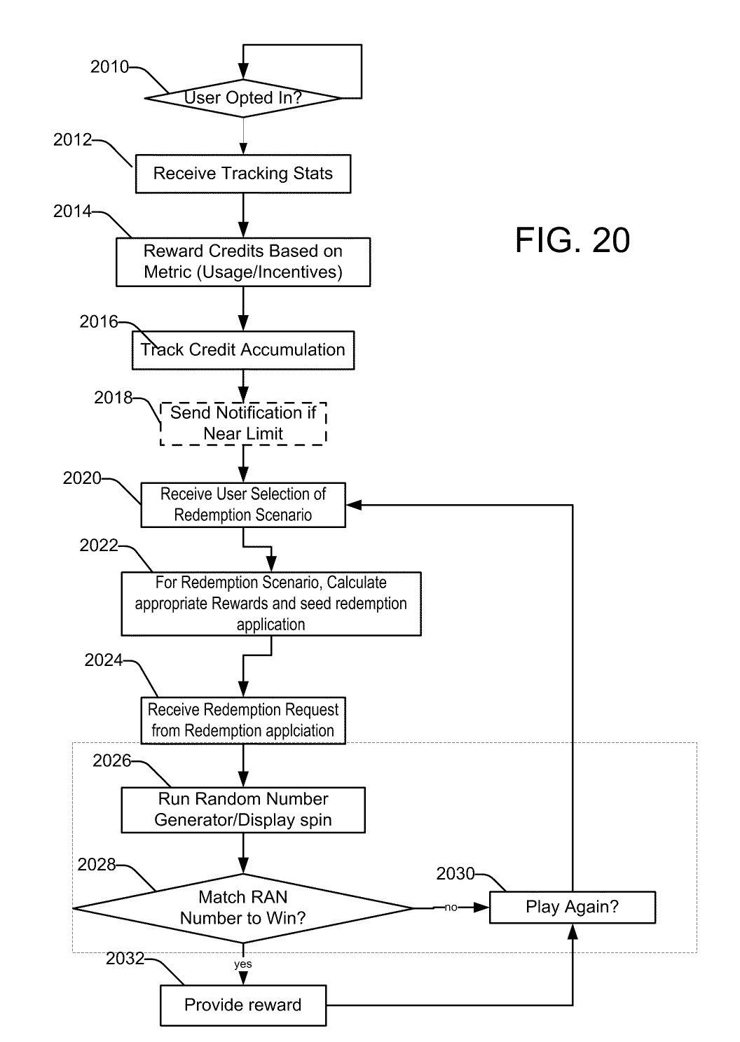

A multiuser service 1802 includes a number of elements such as those illustrated in FIG. 8, and further includes an application registry 1327, application storage 1330, and a record 1342 of applications associated with different users and user account records 1340. Third party applications 1362 developed by a third party developer 1375 may provide any type of application to users of the processing devices 500A, 500B, 500N or 500Y. Illustrated in processing device 500Y is a portion of the system memory 410 disclosed above with respect to FIG. 4 and further including a tracking agent 1850. The tracking agent tracks use of any of the applications on the processing device 300Y, including applications 360A and 360B. In the implementation of FIG. 18, any usage by a user of any of the applications in the processing device 300Y is tracked by the tracking agent and delivered to the reward service 820 to allow provision of redemption tokens in accordance with the technology. The provision of redemption tokens and the redemption of tokens for prizes proceeds in a manner similar to that discussed above, and illustrated below in FIGS. 19 and 20.

FIG. 19 illustrates a process performed by a user in conjunction with the system of FIG. 18. Because the system of FIG. 19 is tracking all usage of all applications, user opt-in may be required at 1902. User opt-in may require the user to acknowledge various terms of use and download the tracking agent 1950 to the user's processing device 300Y. Once the user has opted in at 1902 and the user is authenticated at 1912 by providing the user's gamer tag or other id, and a password, for example. Any use of any application or a selected set of applications by a user at 1914 will generate participation credits for the user. In one embodiment, use of an application to generate participation credit is limited to foreground application usage at 1914. Use of the applications at 1906 can be limited to applications which have been registered by the user reward service 1802 including third party application 1375 or applications generated by the administrator of the user reward service 1802. Participation credits are provided at 1916 (through use of one or multiple applications) and may be subject to a predefined limit, as discussed above. Once a user reaches the predefined limit at 1918, a warning may be provided that the user is reaching the predefined limit. At 1920, a user will select on or more redemption scenarios and select to redeem a chance for a reward at 1922. At 1924, rewards may be generated based on a random number generator and gaming motif, in a manner similar to that discussed above in the various embodiments herein. If the user receives a reward at 1926, digital content may be transmitted to the user in accordance with the foregoing embodiments, or the user may be prompted to play again at 1928, or the user may be directed to a more tangible reward for use in real-life.

FIG. 20 illustrates the process performed by a redemption service in conjunction with the embodiment shown in FIG. 18. At 2010, user opt-in will be checked. If there is no opt-in, the user may not be allowed to proceed. At 2012, the service will receive tracking statistics from the tracking agent. In one embodiment, tracking statistics are provided showing foreground use of applications in an operating environment by the agent polling a task management service on the processing device. At 2014, reward tokens are awarded to the user based on usage statistics received up to a limit at any time. At 2016, token accumulation is tracked per user and, optionally, at 2018 if the amount of tokens accumulated by a user nears the limit, a warning may be sent to the user. At 2020, a selection of a redemption or prize scenario will be received. At 2022, for each redemption scenario, an appropriate reward scenario will be calculated and the redemption application seeded with appropriate prizes. Where the prizes to be awarded do not relate to applications with levels, steps 2022 may be skipped.

At 2024, a redemption credit request will be received by a redemption application. If the application is a direct redemption application, the reward is provided at 1032. Where a chance based motif is used, at 2026, a random number generator is run. This can be performed in conjunction with displaying a game motif, such as a spin game. If the random number generation at 2026 matches a number assigned to a user at 2028, a prize is rewarded at 2032. If not, the user may be prompted to spin again at 2030. Steps 2026, 2028 and 2030 need not be performed where a direct redemption application is used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer implemented method for to provide user incentives to application users, comprising:
tracking use of one or more applications by a user;
providing redemption credit based on the use tracked;
providing a selection of prize redemption scenarios, each scenario including a set of prizes suitable for use in one or more of the applications;
receiving a selection to use the reward redemption credit; and
issuing a prize in response to the use.

2. The computer implemented method of claim 1 wherein tracking use comprises tracking time of use by the user of the one or more applications.

3. The computer implemented method of claim 1 wherein the one or more applications comprises a game and the prize comprises additional content for the same or a different game.

4. The computer implemented method of claim 3 wherein each game includes one or more achievement levels within the game, wherein the user may achieve a level rank in the game, and wherein the set of prizes is provided which is suitable to the users level rank in the game.

5. The computer implemented method of claim 1 wherein each of the prize redemption scenario each scenario including a set of prizes suitable for use in one or more of the games, the prize redemption scenario including prizes suitable an application associated with the scenario, and further including receiving a selection of one of the prize redemption scenarios from the user.

6. The computer implemented method of claim 1 wherein the step of issuing a prize is perfumed randomly, and further including:
providing a redemption application, the redemption application presenting the user a random opportunity to receive a prize comprising a digital product upon redemption of the reward redemption token in the redemption; and wherein said step of receiving a use comprises receiving a redemption through the redemption application.

7. The computer implemented method of claim 6 wherein randomly issuing a prize comprises presenting a game of chance in the application and issuing the digital product in response to a match between a random number generator and the use of the redemption token.

8. The computer implemented method of claim 1 comprising providing a limit on an amount of tokens a user may acquire at one time.

9. A method rewarding users for use of a an application on a processing device, comprising:
tracking user participation in an application;
providing participation credit based on user participation in the application;
providing a selection of prize redemption scenarios, each scenario including a set of prizes suitable for use in the application and one or more additional applications;
receiving a selection of one or the prize redemption scenarios;
providing a redemption application, the redemption application presenting the user an opportunity to receive a prize upon redemption of the participation credit in the redemption application;
receiving a selection to use the participation credit; and
issuing a prize in response to the use.

10. The computer implemented method of claim 9 wherein tracking use comprises tracking time of use by the user of the one or more applications.

11. The computer implemented method of claim 10 wherein issuing a prize comprises randomly issuing a prize in a redemption application having a chance-based motif.

12. The computer implemented method of claim 11 comprising providing a limit on an amount of credit a user may acquire at one time.

13. The computer implemented method of claim 12 wherein the step of providing a selection of prize redemption scenarios includes providing a set of prizes suitable for use in other applications accessible to the user.

14. The computer implemented method of claim 13 wherein each application includes one or more achievement levels within the application, wherein the user may achieve a level rank in the game, and wherein the set of prizes is provided which is suitable to the users level rank in the game.

15. A computer readable medium including instructions for directing a processor to perform a method comprising:
registering one or more applications;
receiving usage information regarding the one or more applications;
providing reward redemption credit to a user based on use of the one or more applications by the user;
selecting a prize set of digital content appropriate for the user based on the user level relative to the digital content;
receiving a selection to use a reward redemption credit from the user;
randomly issuing a digital product in response to the token.

16. The computer readable medium of claim 15 wherein use comprises one of: time of use by a user of one or more applications, or a combination of time of use by a user of one or more applications and application based incentives.

17. The computer readable medium of claim 15 wherein providing reward redemption tokens is limited for a total number of tokens per user at one time.

18. The computer readable medium of claim 15 further including providing a selection of prize redemption scenarios including digital content associated with the one or more applications.

19. The computer readable medium of claim 15 further including receiving one or more applications from a developer and receiving one or more prize sets of digital content from the developer.

20. The computer readable medium of claim 15 further including providing a redemption application, the redemption application presenting an interface to receive the reward redemption token user from the user and present an interface indicating issuance or non-issuance of the digital product.
